(19) United States
(12) Patent Application Publication
(10) Pub. No.: US 2008/0145590 A1
(43) Pub. Date: Jun. 19, 2008

(54) Heat Insulating Cover

(76) Inventor: Patricia A. Cisar, Wenatchee, WA (US)

Correspondence Address: Patricia A. Cisar, 1450 Castlerock Ave. # 15, Wenatchee, WA, 98801, US

(21) Appl. No.: 12/038,194

(22) Filed: Feb. 27, 2008

Related U.S. Application Data
(62) Division of application No. 10/682,220, filed on Oct. 9, 2003.
Application No. 10/682,220 is a continuation-in-part of application No. 10/016,114, filed on Dec. 12, 2001, now Pat. No. 7,065,394.

(51) Int. Cl. B32B 7/00

(52) U.S. Cl. 428/68

(57) ABSTRACT

Disclosed is a heat insulating cover for disposition on a heat exhaust system of a vehicle for minimizing a contact between a vehicle rider and heat released by the heat exhaust system. The heat insulating cover includes an insulating sheet and at least one covering sheet. The insulating sheet has a first surface and a second surface opposite to the first surface. The at least one covering sheet is disposed on at least one of the first surface and the second surface of the insulating sheet. The heat insulating cover is disposed on the vehicle in a manner such that a central portion of the heat insulating cover is positioned beneath a section of the vehicle (for example, a vehicle seat), with a first side portion and a second side portion of the heat insulating cover covering the heat exhaust system of the vehicle on both sides of the vehicle.

### FIELD OF THE INVENTION

The present invention relates generally to heat insulating covers, and, more particularly, to a heat insulating cover for disposition on a heat exhaust system of a vehicle.

### BACKGROUND OF THE INVENTION

During long distance journeys, a vehicle runs continuously for a substantially long time. Due to the long running time, a heat exhaust system of the vehicle, for example, an engine of the vehicle is subjected to overheating.

More specifically, while driving a two-wheeled vehicle, such as a motorcycle, the lower portion of torso of a motorcycle rider remains in proximity to the heat exhaust system of the motorcycle. For example, the thighs and legs of the motorcycle rider remain in close proximity with a motorcycle engine, thereby exposing the motorcycle rider to the heat released by the vehicle heat exhaust system, which might result in injuries (such as burns and blister formation) to the motorcycle rider.

In order to address this situation, the vehicles are configured with a cooling system for cooling the overheated vehicle engine. However, for a long distance journey, the cooling provided by a cooling system of the vehicle is insufficient.

Accordingly, there exists a need for a heat insulating system capable of minimizing a contact between a vehicle rider and the heat released by a heat exhaust system of the vehicle in an easy and reliable manner.

### SUMMARY OF THE INVENTION

In view of foregoing disadvantage inherent in the prior art, the general purpose of the present invention is to provide a heat insulating cover, to include all the advantages of the prior art, and overcome the drawbacks inherent therein.

An object of the present invention is to provide a heat insulating cover capable of being disposed on a heat exhaust system of a vehicle, thereby minimizing a contact between a vehicle rider and heat released by the heat exhaust system of the vehicle.

Another object of the present invention is to provide a heat insulating cover for use during a long distance journey. More specifically, the heat insulating cover may be capable of being removably disposed on a vehicle for covering the heat exhaust system of the vehicle.

Yet another object of the present invention to provide a portable heat insulating cover that is easy and convenient to use during a long distance journey.

In light of the above objects, in one aspect of the present invention, a heat insulating cover adapted for disposition on a heat exhaust system of a vehicle is provided. Accordingly, the heat insulating cover limits the exposure of a vehicle rider to the heat released by the heat exhaust system of the vehicle. The heat insulating cover disclosed herein includes an insulating sheet and at least one covering sheet. The insulating sheet includes a first surface and a second surface opposite to the first surface. The at least one covering sheet is disposed on at least one of the first surface and the second surface of the insulating sheet. The heat insulating cover is disposed on the vehicle in a manner, such that, a central portion of the heat insulating cover is positioned beneath a section of the vehicle (for example, a vehicle seat), with a first side portion and a second side portion of the heat insulating cover covering the heat exhaust system of the vehicle on both sides of the vehicle.

In another aspect of the present invention, a heat insulating cover having a first covering sheet, a second covering sheet and an insulating sheet is provided. More specifically, the first covering sheet is disposed on a first surface of the insulating sheet, and the second covering sheet is disposed on a second surface of the insulating sheet. The heat insulating cover is disposed on the vehicle in a manner such that a central portion of the heat insulating cover is positioned beneath a section of the vehicle (for example, a vehicle seat), with a first side portion and a second side portion of the heat insulating cover covering the heat exhaust system of the vehicle on both sides of the vehicle.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates an exploded perspective view of a heat insulating cover for a vehicle, in accordance with an embodiment of the present invention;

FIG. 2 illustrates a top view of a heat insulating cover, in accordance with an embodiment of the present invention; and

FIG. 3 illustrates the heat insulating cover of FIG. 2 disposed on a vehicle for covering a heat exhaust system of the vehicle, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to a heat insulating cover, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a heat insulating cover for a vehicle, for example, a motorcycle. The heat insulating cover is capable of minimizing a contact between a vehicle rider and heat released by a heat exhaust system of the vehicle. More specifically, when the vehicle is driven for a long time, the heat exhaust system of the vehicle may get overheated; thereby preventing the vehicle rider to comfortably position his/her legs on the vehicle. The heat insulating cover disclosed herein may be disposed on the vehicle to shield the vehicle driver from the heat exhaust system of the vehicle in an easy and reliable manner.

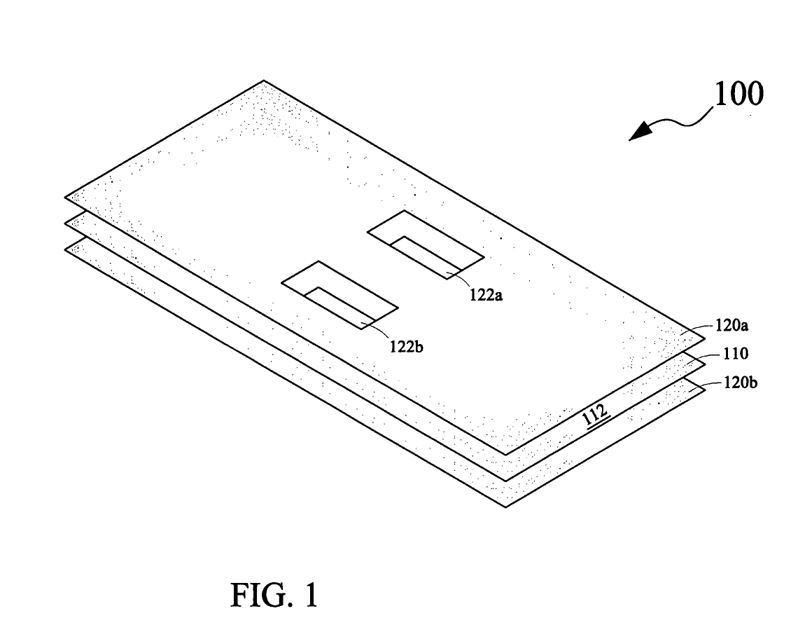

With reference to FIG. 1, an exploded perspective view of a heat insulating cover 100 is illustrated. The heat insulating cover 100 includes an insulating sheet 110 having a first surface 112 and a second surface (not shown), such that the second surface is opposite to the first surface 112. The insulating sheet 110 may be made of a temperature resistant material for withstanding high temperatures due to heat released by the heat exhaust system of the vehicle. For example, the insulating sheet 110 may be made of Insulbrite material, a thermosetting material or any similar temperature resistant material that resists transfer of heat.

The heat insulating cover 100 further includes at least one covering sheet disposed on at least one of the first surface 112 and the second surface of the insulating sheet 110. In one embodiment of the present invention, the heat insulating cover 100 includes two covering sheets for covering the first surface 112 and the second surface (not shown) of the insulating sheet 110. As illustrated in FIG. 1, the heat insulating cover 100 includes a first covering sheet 120a disposed on the first surface 112 of the insulating sheet 110; and a second covering sheet 120b disposed on the second surface of the insulating sheet 110. The covering sheets 120a, 120b are sized and designed to cover the insulating sheet 110 in a manner for enhancing aesthetic appearance of the heat insulating cover 100. The covering sheets 120a, 120b may be made of any natural or synthetic material. Preferably, the covering sheets 120 may be made of a leather material.

In another embodiment of the present invention, the heat insulating cover 100 includes only one covering sheet (such as the covering sheet 120a) disposed on the insulating sheet 110. Preferably, in such a case, the heat insulating cover is disposed on the vehicle, such that, the covering sheet 120a configures a top side of the heat insulating cover 100 and the insulating sheet 110 configures a bottom side of the heat insulating cover 100.

The covering sheets 120a, 120b are disposed on the insulating sheet 110 in a manner to be firmly attached to the insulating sheet 110 to form a unitary covering system for heat insulation (herein the heat insulating cover 100). Suitable attachment arrangements for attaching the covering sheets 120a, 120b to the insulating sheet 100 include, but are not limited to, a sewing arrangement, a Velcro arrangement, a hook arrangement, an adhesive arrangement, and an ultrasonic bonding arrangement.

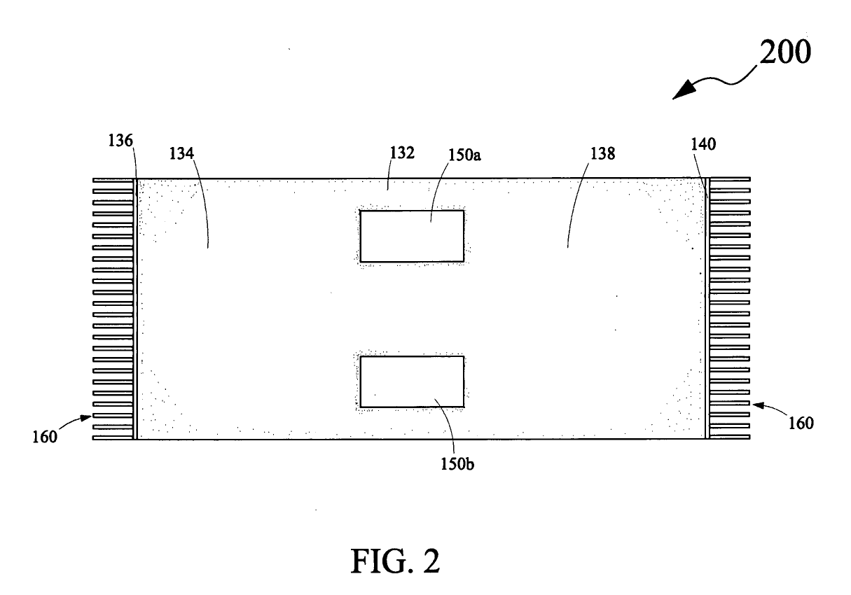

The heat insulating cover 100 disclosed herein includes at least one opening, for example, openings 122a and 122b, configured thereon. The openings 122a, 122b enable protrusion of at least one component of the vehicle from the heat insulating cover 100, when the heat insulating cover 100 is disposed on the vehicle. Such openings 122a, 122b aid in appropriately disposing the heat insulating cover 100 on the vehicle. More specifically, each of the covering sheets 120a, 120b and the insulating sheet 110 includes openings aligned collectively to configure openings 122a and 122b of the heat insulating cover 100, as explained in conjunction with FIG. 2.

In one embodiment of the present invention, the heat insulating cover 100 may include a single opening instead of the multiple openings. The single opening may be sized sufficiently to enable protrusion of different components of the vehicle from the heat insulating cover 100, as compared to the presence of smaller sized multiple openings to enable protrusion of the different components of the vehicle.

FIG. 2 illustrates a top view of a heat insulating cover 200, in accordance with an embodiment of the present invention. More specifically, a top side of the heat insulating cover 200 is described in conjunction with FIG. 2. However, it will be apparent to a person skilled in the art, that a symmetrical bottom side will involve a similar description. The heat insulating cover 200 includes all configurational aspects described with regard to the heat insulating cover 100 of FIG. 1. As illustrated in FIG. 2, the heat insulating cover 200 has a central portion 132, a first side portion 134 extending from the central portion 132 to a first lateral edge 136, and a second side portion 138 extending from the central portion 132 to a second lateral edge 140.

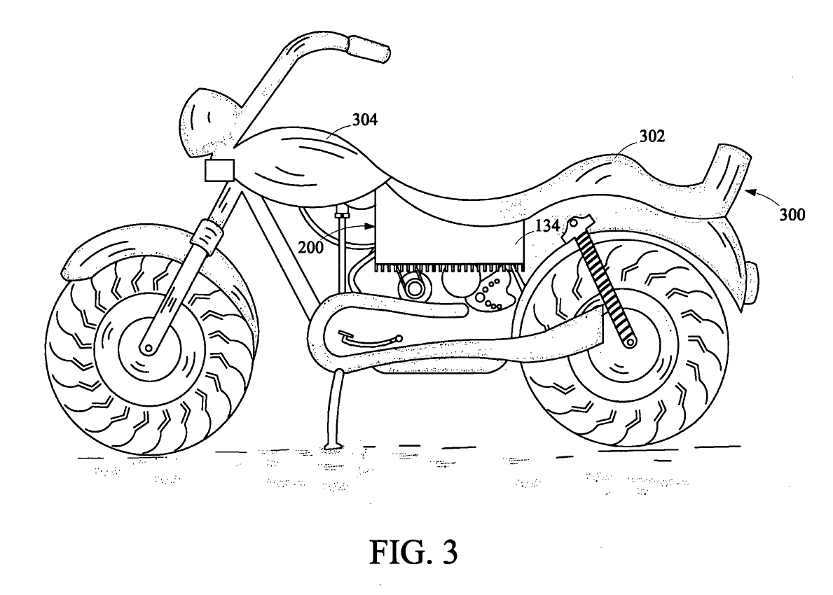

Preferably, the heat insulating cover 200 is disposed on the vehicle in a manner such that a substantial part of the central portion 132 is positioned beneath a section of the vehicle (for example, a vehicle seat), with the first side portion 134 and the second side portion 138 covering the heat exhaust system of the vehicle on both sides of the vehicle. Such an arrangement prevents the vehicle rider to come in direct contact with the heat released by the heat exhaust system of the vehicle. The disposition of the heat insulating cover 200 on the vehicle, more specifically, a motorcycle, is described herein in conjunction with FIG. 3.

As explained in conjunction with FIG. 1, the heat insulating cover 200 includes multiple openings 150a, 150b (similar to the openings 122a, 122b illustrated in FIG. 1) configured thereon. As illustrated in FIG. 2, preferably, the multiple opening 150a, 150b are configured on the central portion 132, since it is the central portion 132 that is secured beneath a section of the vehicle (for example, a vehicle seat) with the first side portion 134 and the second side portion 138 hanging on both sides of the vehicle. The openings 150a, 150b enable protrusion of at least one component of the vehicle configured beneath the section of the vehicle, from the heat insulating cover 200.

For example, while disposing the heat insulating cover 200 underneath a vehicle seat, the components of the vehicle beneath the vehicle seat (battery, wiring, and the like) may cause a hindrance in proper installation of the heat insulating cover 200. The presence of openings 150a, 150b enables protrusion of battery, wiring, and the like from the heat insulating cover 200; thereby aiding in appropriate disposal of the heat insulating cover 200 on the vehicle with the central portion 132 of the heat insulating cover 200 firmly secured beneath the vehicle seat.

The heat insulating cover 200 may include one or more attachments for enhancing the aesthetic appearance thereof. For example, the heat insulating cover 200 may include fringes 160 coupled to the lateral edges 136, 140 of the heat insulating cover 200. It should be apparent to a person skilled in the art that the heat insulating cover 200 may include other decorative arrangements for enhancing the aesthetic appearance thereof, without deviating from the scope of the present invention. For example, the heat insulating cover 200 may include stickers, embroidered designs, beads and other decorative embellishments, logos, product and/or source identifiers, and the like.

FIG. 3 illustrates the heat insulating cover 200 of FIG. 2 being disposed on a vehicle, such as a motorcycle 300 for covering a heat exhaust system of the motorcycle 300. As used herein, the heat exhaust system of the motorcycle 300 includes an engine (not shown), an oil tank (not shown), and a radiator (not shown). The heat insulating cover 200 is disposed on the motorcycle 300 by positioning the heat insulating cover 200 under a motorcycle seat 302. More specifically, the motorcycle seat 302, hereinafter referred to as the seat 302, may be lifted and the central portion 132 (FIG. 2) of the heat insulating cover 200 may be positioned under the seat 302. The openings 150a, 150b (FIG. 2) configured on the central portion 132 of the heat insulating sheet 200 may be adjusted under the seat 302 such that the components, for example, the battery and the external wiring of the motorcycle 300, may protrude from the openings 150a, 150b. Moreover, the side portions 134 and 138 (FIG. 2) of the heat insulating cover 200 may hang on both sides of the seat 302, thereby covering the heat exhaust system of the motorcycle 200.

Also, as shown in FIG. 3, a peripheral portion of the central portion 132 (FIG. 2) of the heat insulating cover 200 may be positioned under a gas tank 304 of the motorcycle 200, thereby rigidly disposing the heat insulating cover 200 on the motorcycle 300. Preferably, the peripheral portion may have a width of about two inches for enabling easy sealing of the seat 302 on the motorcycle 300 after the heat insulating cover 200 is disposed on the motorcycle.

In use, when the heat insulating cover 200 is disposed on the motorcycle 300, the first side portion 134 and the second side portion 138 (FIG. 2) of the heat insulating cover 200 hangs from the seat 302 towards the engine and the radiator, thereby covering the heat exhaust system on both sides of the motorcycle 300. The heat insulating cover 200 minimizes the exposure of a vehicle rider to the heat released by the heat exhaust system of the motorcycle.

Keeping in consideration the standard size of existing motorcycles, the heat insulating cover 100 (FIG. 1), 200 (FIG. 2) as disclosed herein may assume a rectangular configuration having a length of about 16 inches and a width of about 12 inches. However, it will be evident to a person skilled in the art that the heat insulating cover 100, 200 may have different dimensions and designs based on different configurations of motorcycles and other vehicles. Also, the heat insulating cover 200 may be made in a variety of colors to match a color of the vehicle.

The present invention discloses a heat insulating cover for use with a vehicle, for example, a motorcycle. More specifically, during long distance journeys, the heat insulating cover may be disposed on the vehicle for avoiding any harm to a vehicle rider due to heat released from a heat exhaust system of the vehicle. Further, the heat insulating sheet may be removed, folded and stored in a storing device configured on the motorcycle, thereby enabling easy portability of the heat insulating cover.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. A heat insulating cover adapted for disposition on a heat exhaust system of a vehicle comprising:
an insulating sheet comprising a first surface and a second surface opposite to the first surface; and
at least one covering sheet disposed on at least one of the first surface and the second surface of the insulating sheet.

2. The heat insulating cover of claim 1, wherein the vehicle is a motorcycle.

3. The heat insulating cover of claim 1, wherein the insulating sheet is made of a temperature resistant material.

4. The heat insulating cover of claim 1, wherein the at least one covering sheet is made of a leather material.

5. The heat insulating cover of claim 1, wherein the at least one covering sheet comprises
a first covering sheet disposed on the first surface of the insulating sheet, and
a second covering sheet disposed on the second surface of the insulating sheet.

6. The heat insulating cover of claim 1, wherein the heat insulating cover is disposed on the vehicle in a manner such that a central portion of the heat insulating cover is positioned beneath a section of the vehicle with a first side portion and a second side portion of the heat insulating cover covering the heat exhaust system of the vehicle on both sides of the vehicle.

7. The heat insulating cover of claim 6, further comprising at least one opening for enabling protrusion of at least one component of the vehicle configured beneath the section of the vehicle.
